(19) United States
(12) Patent Application Publication
(10) Pub. No.: US 2024/0423415 A1
(43) Pub. Date: Dec. 26, 2024

(54) Apparatus and Method for Removing Oil from Fried Foods

(71) Applicant: Heat and Control, Inc., Hayward, CA (US)

(72) Inventors: Leopoldo Zarate Andrade, Tlajomulco de Zuniga (MX); Andrew Anthony Caridis, San Carlos, CA (US)

(73) Assignee: Heat and Control, Inc., Hayward, CA (US)

(21) Appl. No.: 18/709,755

(22) PCT Filed: Nov. 22, 2022
(86) PCT No.: PCT/IB2022/061288

§ 371 Date: May 13, 2024

(30) Foreign Application Priority Data
Nov. 22, 2021 (MX) MX/A/2021/014296

(51) Int. Cl. A47J 37/12

(52) U.S. Cl. CPC A47J 37/1271

(57) ABSTRACT

A method for removing excess oil from a plurality of food items is provided and can include placing the plurality of food items in a sequential manner on a conveyor advanceable in a direction of travel. Each of the plurality of food items can be inclined upwardly at an angle relative to the direction of travel of the conveyor. A stream of hot air can be blown downwardly towards a side periphery of the plurality of food items to remove excess oil from the plurality of food items. An apparatus relating to the method is provided.

This application claims priority to Mexican patent application Serial No. MX/2021/084322 filed Nov. 22, 2021, the entire content of which is incorporated herein by this reference.

### TECHNICAL FIELD

The present invention is directed to removing oil from fried foods, and more particularly to removing oil from fried foods with a blower.

### BACKGROUND

Various efforts have been directed to the removal of excess oil on fried foods. This is due to regulations in some jurisdictions as well as growing consumer awareness in recent years regarding fat consumption. The foregoing has caused some manufacturers of fried foods for human consumption to amend their processes to incorporate equipment to help remove excess oil from their food products, with the goal of being able to provide the market with lower fat content fried foods. Traditionally, the removal of excess oil from fried foods has been undertaken by means of gravity. For example, once the food has been fried, the food is extracted from the frying bucket by means of a strainer. The fried food is left so that it can drip, the dripped oil collected by means of a tray. In other cases, the strainer has been integrated within the frying bucket, which allows for extracting the product immersed in the oil and placing the product over an inclined platform. This allows the product to be cooled and drained, and some of the oil to be recovered and reach the next work station by gravity.

JP09206223 by Kenzi et. al. describes an apparatus and process through which the fried product is set on a conveyor. Upon reaching a middle point the product is pressed by a second network conveyor in such a way that the product is sandwiched by both conveyors. Hot air is directed towards the product by a series of nozzles. The hot air increases the fluidity of oil exposed on the surface of the product, which helps with its removal. The air is heated by means of a heater coupled with a fan.

U.S. Pat. No. 2,902,921 by Brodrick shows an apparatus for separating fats of cooked products, that is used in conjunction with a deep fryer. A heater, a fan with a duct and a nozzle directs hot air towards the grill where the product to be dried.

ES2173542 by Pluschow et. al. shows a packaging conveyor with a chain conveyor made up of by a plurality of links with portable lids forming a support surface on which dragging fingers can be placed. MX282623 by Constanzo et al illustrates a conveyor with a plurality of links which house a plurality of dredges at longitudinally separated intervals to form drawers between consecutive dredges.

Despite the options available in the field, a need still exists for oil strippers which can more efficiently remove cooking oil from the surface of fried foods.

### BRIEF DESCRIPTION OF DRAWINGS

FIG. 1 is an isometric view of an embodiment of the apparatus for removing oil from fried foods of the present invention.

FIG. 2 is a front elevational view of the appartus of [FIG. 1].

FIG. 3 is a top plan view of the apparatus of [FIG. 1].

FIG. 4 shows a lateral view of an embodiment of the conveyor belt with shelves of the apparatus of [FIG. 1].

FIG. 5 is a top view of a portion of the conveyor belt of [FIG. 4].

FIG. 6a is a schematic view of an embodiment of the air flow in the upper chamber of the apparatus of [FIG. 1].

FIG. 6b is an isometric view of an embodiment of a heater of the apparatus of [FIG. 1].

FIG. 7 is an isometric view of an embodiment of a fan, motor and guard assembly of the apparatus of [FIG. 1].

FIG. 8 is a schematic view of an embodiment of the air flow of the apparatus of [FIG. 1].

FIG. 9a is a schematic view of an embodiment of the flow chart of the lateral section of a duct of the apparatus of [FIG. 1].

FIG. 9b is an isometric view of the duct of FIG. 9a.

FIG. 10 is a flow chart of an embodiment of the method for removing oil from fried food of the present invention.

### DETAILED DESCRIPTION OF THE INVENTION

The following definitions are provided with the goal of allowing a better understanding of the invention:

Mechanical fastening or mechanically fixed, or mechanically fasten or mechanically fastened, refers to the joining of two or more parts by means of screws, nuts, rivets, welding by arc, wire welding or friction, glues, any other mechanical means or fasteners of any suitable type or any combination of the foregoing.

Oil removal means refers to any type of means which separates the oil contained in air, for example a stream of air, and includes but is not limited to filters, mist pad type filters, oil separators, scrubbers, oil separation by means of centrifuge, separators of condensers, air washers, any type of means for separating the air contained in a torrent of air or any combination of the foregoing.

Mechanical coupling or mechanically coupled or mechanical joint refers to the transmission of mechanical energy from one element to another by any suitable means, including for example gears, friction pulleys, pulleys with bands, magnetic means, and mechanical transmissions or any combination of the foregoing.

The use of the term “approximately” provides an additional determined range of +10% regarding the numeric value to which it is applied. By way of example, “approximately 40 grams” comprises between 36 to 44 grams.

The method and apparatus of the invention remove excess oil from the surface of food items, for example fried edible goods, which can optionally be referred to as foodstuff, fried foodstuff, edible goods, fried goods, or any combination of the foregoing. The edible goods or food items can be of any suitable type, including for example any suitable raw food item such as a vegetable, tubercle, potatoe, yucca, sweet potato, taro, carrot, onions, garlic, cauliflower, broccoli, gourd, asparagus, cayenne, paprika, a variety of vegetables, mushroom, any fungi variety of food items, fruit, red tomato, green tomato, plantain, bananas, meat, chicken meat, beef, pork, or pork skin to produce pork rind. The food items can optionally include and food items made of any type of dough, for nixtamalized corn dough, masa, flour, or wheat flourdough. Such food items made of dough can be of any suitable type, for example tortillas, tostadas, any corn masa product, fritters, churros, puffs, doughnuts, doughnuts holes or any fry product made of dough. The food items can optionally include items in which corn masa or flour dough is used to cover a vegetable, edible fungi, any kind of meat, Japanese tempura, Chinese rolls, a stew, Mexican fried tacos, fry stew quesadillas, fried pork rind gorditas, fried stew gorditas, fried tamales, or Kentucky style chicken. The food items can optionally include other types of dishes, culinary specialties, edible cooked products or any combination of the foregoing.

The food item can be of any suitable shape and optionally have a periphery, which can optionally be referred to as a side periphery, extending around the food item. The periphery can optionally be referred to as an edge or peripheral edge of the food item. The food item can optionally be relatively flat, for example have a relatively flat surface or face across the food item between the periphery or edge of the food item. The relatively flat surface and include the front surface of the food item, the back surface of the food item or both. The food item can optionally be discoidal in shape, for example tostadas from tortillas and corn chips. The food items can be of a variety of other shapes, for example potato slices, potato sticks, french fries, cheese sticks, fish sticks, chicken sticks, chicken fingers, fried corn strips, triangular shaped or rolled fried corn. The food item can optionally be brittle or fragile, for example easily crumble or fall apart.

The method and apparatus can include blowing air, or another gas, towards the periphery or edge of the food item. The air can continue from the periphery or edge across a surface of the food item, for example a face of the food item. The air can optionally travel across the front surface or face of the food items. The air can optionally be directed downwardly towards the food item so that gravity assists in the removal of the excess oil from the food item. The food item, for example the periphery, side periphery or edge of the food item, can optionally extend parallel or approximately parallel to the flow of air. The flow of air can optionally serve to drag excess oil across the food item, for example before separating the excess oil from the food item. The food item, for example the periphery or edge of the food item, can optionally extend at an acute angle to the flow of air. Such angle can optionally range from zero to 60 degrees. Such angle can optionally range from zero to 45 degrees. Such angle can optionally range from zero to 30 degrees. Such angle can optionally range from zero to 15 degrees. Such angle can optionally range from zero to five degrees. A blower of any suitable type can be provided for blowing air towards the food items. The blower can include a fan and a nozzle for directing the air in a desired manner.

The air can optionally be heated, for example to reduce the viscosity of the excess oil so as to assist in removing the excess oil from the food item. The angle of the air flow towards the food item can optionally be fixed. The angle of the air flow towards the food item, for from food item to food item, can optionally vary, for example as a function of a variety of factors that can optionally include the type of food item.

Where a plurality of food items are provided for processing, relative movement between the air flow and the plurality of food items can optionally be provided, for example to assist in automating the apparatus and method of the invention. For example, a flow of air can move across a plurality of food items, for example sequentially from one or more food items to one or more other food items. Such plurality of food items can optionally be stationary or optionally movable. A plurality of food items can optionally move relative to a stationary air flow, for example sequentially through or across a stationary air flow. Such movement of the plurality of food items can be by any suitable means, for example a conveyor, rollers, a transporter, a movable support structure, an elevator, an escalator, movable food item receptacles or any combination of the foregoing, and for simplicity herein can be referred to herein as a conveyor.

Any suitable support structure or receptacle can be provided for receiving and supporting one or more food items while air is directed at the food items for removing excess oil from the food items. The support structure or receptacle can optionally have a space, or plurality of spaces, for respective receiving one or more food items. The support structure or receptacle can optionally include a side surface or lip extending outwardly from the main support surface of the rack for supporting the one or more food items on its edge or periphery. The width and length of the space can each optionally be substantially larger than the depth of the space for receiving a food item that is relatively flat. The support structure or receptacle can optionally receive and hold the one or more food items free of compressive forces so as to not damage the one or more food items. The support structure or receptable can optionally be at least partially or totally air permeable so that air can easily flow through the support structure or receptable. The support structure or receptable can optionally be a cage or cagelike. The support structure or receptacle can optionally be a framework, for example formed from a plurality of interconnected elements, members, bars, cylinders, strips, tubular elements or members or any combination of the foregoing. The support structure or receptable can be made from any suitable material, for example stainless steel, metal, plastic or any combination of the foregoing. The support structure or receptable can be of any suitable size and shape. The support structure or receptable can optionally have six rectangular sides or faces. The support structure or receptable can optionally have a length and width substantially larger than its depth. The width of the support structure or receptacle can optionally approximate the width of the conveyor. A plurality of support structures or receptables can optionally be carried by a conveyor, for example sequentially disposed along the length of the conveyor.

The method and apparatus can optionally include any suitable oil removal means, for example to remove oil contained in air that has passed over one or more food items. The process of removing excess oil from air can optionally be referred to as oil stripping. The air that has passed through the oil removal means can optionally be used again for removing excess oil from other food items. The air for reuse can optionally be heated before reuse.

The apparatus and method of the invention can optionally include a conveyor of any suitable type, for example for carrying a plurality of receptacles spaced sequentially along the conveyor. The conveyor can optionally be a high precision chain conveyor. The conveyor can optionally include a plurality of links for supporting the plurality of receptacles. Each receptacle can optionally include a rack, link rack, shelf, platform or support structure, for example an air permeable rack, link rack, shelf, platform or support structure, for receiving and at least partially supporting a food item. The plurality of receptacles can optionally include a plurality of racks, link racks, shelves, platforms or support structures spaced apart along the conveyor. For simplicity, each rack, link rack, shelf, platform or support structure shall be referred to herein as a rack. The space between adjacent racks can receive one or more food items for processing, and can be referred to as part of the receptacle. Each rack can optionally be as long as the links of the conveyor. Each rack can optionally have a width approximating the width of the conveyor. The plurality of racks can help separate and transport edible goods or foodstuff set on the conveyor in small lots.

The edible goods or foodstuff to be processed by the apparatus and method of the invention can optionally have been subjected to a frying process. A typical frying process can utilize a wide variety of edible oils or edible fats, including for example palmolein oil, safflower oil, olive oil, corn oil, sunflower oil, coconut oil, sesame oil, canola oil, animal oils, Ghee butter, butter, margarine or any combination of the foregoing. The edible goods or foodstuff to be processed can optionally be driven after the frying process to an end of the conveyor for receipt by respective receptacles of the invention. The receptacles transport the food items with utmost care. In this regard, many edible goods or foodstuff, for example corn tostadas, are highly fragile and brittle after the frying process.

The apparatus and method of the invention can optionally transport food items, for example tostadas, vertically or approximately vertically. The food items can optionally be set on their edge. The food items are optionally separated in small lots between racks of the receptacles. Each rack, and thus each receptacle, can transport one or more food items. For example, in some embodiments each receptacle can transport between approximately five to 300 edible goods or foodstuff. Such vertical or approximate vertical alignment of one or more food items in a receptacle, for example parallel or approximately parallel to the direction of air flow, can help to expose the front surface, the back surface or both of the food item to a stream of hot air stream emanating from a blower or pressurized air source of any suitable type, for example directed at the edge, periphery or side periphery of the one or more food items in the receptacle. The air can optionally be heated, for example to a temperature higher than room temperature, which can reduce the kinetic viscosity and density of the oil on the surface of the fried products and contribute to the oil being in a liquid form. Such fluidity of the oil facilitates it being dragged by the air stream along the food item, off the food item or both. The temperature, direction and speed of the air stream can optionally be controlled to provide that the oil present on the surface of a food item has adequate fluidity for its case of removal when an air stream is directed at the food item.

A controlled flow speed and direction of the air stream can be achieved by any suitable manner, including for example with a nozzle. The nozzle is able to transport, give direction, maintain or increase the air flow speed and target a specific area, for example on the receptacles or conveyor of the invention, where food items to be stripped of oil are placed. The use of a nozzle can facilitate the use and design of a compact, closed air loop system for oil stripping that is very effective at stripping oil out of the foodstuff, easy to manufacture, reliable and possess low construction and running costs. The nozzle can optionally be in flow communication with a squirrel cage type fan, which can produce an air stream in the form of an air curtain or shower at the exhaust of a nozzle. The nozzle can optionally extend across or along the width of the conveyor. The nozzle can optionally provide an even speed hot air curtain or shower or jet over the foodstuffs present on the conveyor so as to drag the oil present in the surfaces of the foodstuffs, for example off the foodstuffs. A single nozzle can be advantageous when compared to systems utilizing a plurality of nozzles, a plurality of fans (axial or centrifugal flow) or both as it is well known that using a plurality of nozzles with a multitude of fans produces air cones that can provide zones along the width of a conveyor where the air speed is not uniform, resulting in poor oil dragging between air cones.

In the apparatus and method of the invention, hot air, including for example oil stripped hot air, showers the edible goods or foodstuff, for example placed in the receptacles of the conveyor. The edible goods or foodstuff in the air permeable receptacles are immersed in hot air, which drags the oil on the surface of the foodstuff, including for example off of the foodstuff. After the air has passed through the receptacles, for example is underneath the conveyor, it has cooled and become saturated with the oil collected from the foodstuffs. The oil rich cooled air can then optionally travel into a lower chamber of the apparatus of the invention, where a first oil removal means is optionally provided. The first oil removal means can retain the oil particles contained in the oil rich cooled air, which oil particles can optionally drip into a hopper with a gully. The first oil stripped cool air can optionally be driven to an air chamber plenum by means of at least one duct. A pair of twin ducts can optionally be employed in this regard. The twin ducts can optionally have a second oil removal means, which can help to further strip oil from the air as well as collect air impurities. Cooled air that travels through the second oil removal means is cleaned of air impurities as well as residual oil particles. The at least one duct, for example twin ducts, can optionally direct the cooled oil desiccated air from the lower chamber to an upper chamber air chamber plenum, wherein oil stripped air can optionally be heated by means of a heater of any suitable type, for example a heat exchanger with electric or gas heaters (burners). The at least one duct, for example twin ducts, can optionally be referred to as a transfer duct. Such oil stripped hot air can optionally be suctioned by a fan that delivers it to the blower of the invention, for example the nozzle, for reuse in removing or stripping oil for additional food items.

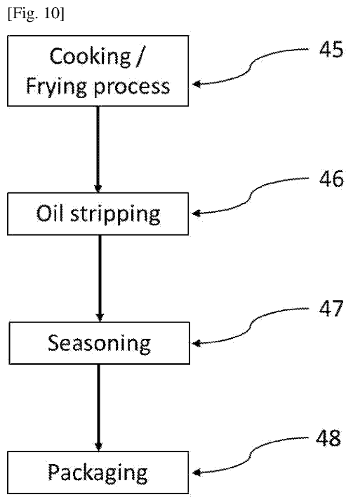

FIG. 10 shows a simplified food process diagram of an embodiment of the invention. The process of [FIG. 10] commences with cooking/frying block 45, where raw foodstuffs or food items get cooked in any suitable manner. The cooking of block 45 can optionally include any suitable cooking frying process by oil immersion, for example where the raw food items are brought in contact with or immersed in hot edible cooking oil contained in a pan, pot, pool or other suitable container. The edible oil can be of any suitable type, including any discussed above or herein. The food items can be of any suitable type, including any discussed above for herein. The cooked product, for example from step 45, can optionally be referred to as a fried cooked edible product or fried product. In a next step, for example step 46, excess oil is removed from the fried product in any suitable manner. In some cases, the oil stripping process includes optionally placing a wire basket containing the fried product on top of a frying pot or container to let the excess oil drip into the container with no forced air convection. In some cases, the fried products are optionally placed aside the cooking pan, plate or griddle to sit for a while dripping oil, again with no aid to help the excess oil stripping process. The method and apparatus of the invention removes in an efficient manner excess oil that the fried product possess in its outer layer, skin or outer surface due to the cooking or frying process that it was subjected to. As shown in [FIG. 10], the oil stripping step or process can optionally take place between the cooking/frying step or process 45 and the seasoning step or process 47. The oil stripping process 46 can optionally use the apparatus of the invention, including the apparatus described herein. The oil stripping process 46 is intended to take off, remove, strip or scrub the oil present in the outer layer, skin or outer surface of the fried product. The excess oil is optionally dragged using air convection forces that promote the transfer of the oil present in the outer layer, skin or outer surface of the fried product to the forced air stream or air that showers or jets the fried product. The method and apparatus of the invention are capable of removing 1% to 5% in weight of the oil content in a given cooked edible good or fried product.

In the seasoning step or process 47 of the simplified food process diagram of [FIG. 10], the oil stripped food item can optionally be seasoned in any suitable manner, for example salt, garlic, chile powder, herbs, spices, condiments, sugar, caramel, frosting, an edible coating among other seasoning granules, dust, powder, covers or any combination of the foregoing, to enhance the flavor or decorates the food item.

In the packaging step or process 48 of the simplified food process diagram of [FIG. 10], the oil stripped food item, for example the seasoned food item from step or process 47, is readied for delivery to the customer. The food item can be packaged in bunch of food items or in an individual fashion, for example as a function of the type or kind of food item, marketing strategies, specific packaging needs, other packaging requirements or any combination of the foregoing. The oil stripping process of the invention inhibits oil dripping from the food items within the package, providing a better image to the packaged food items by inhibiting the undesirable collection of oil at the bottom of or elsewhere on the package that in some events can damage the package. The handling of packaged food items can result in any dripped oil collected in a package returning to the surface of the food items.

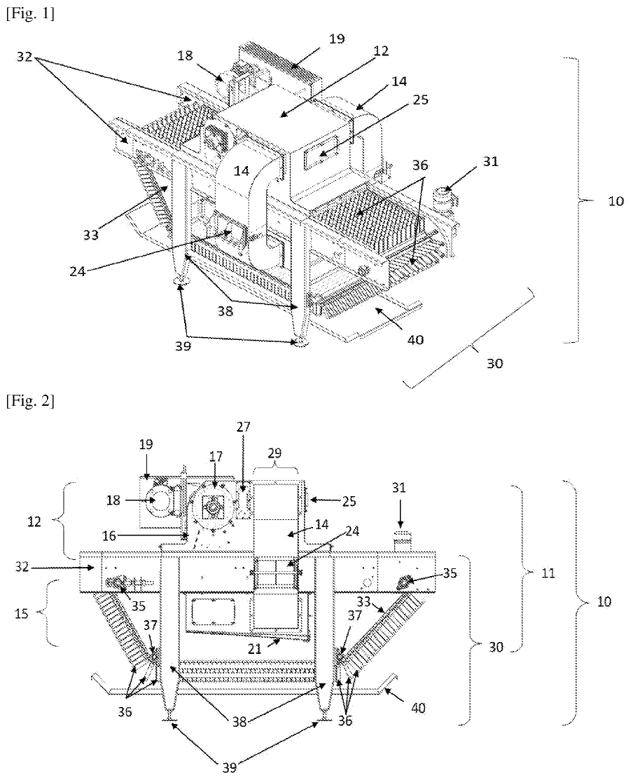

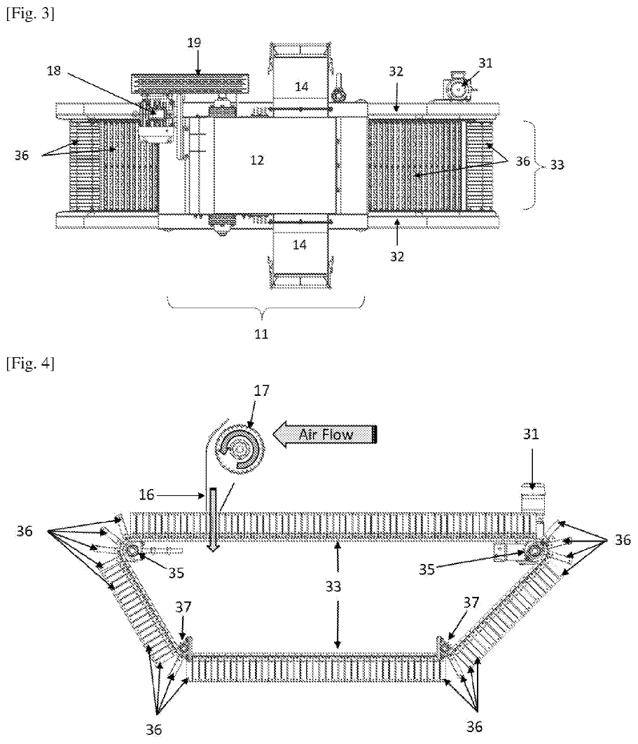

An embodiment of an apparatus of the invention, which can optionally be referred to as an oil stripper or stripping apparatus 10, is shown in FIGS. 1, 2, 3, 6a and 8. Apparatus 10 can optionally be utilized in oil stripping step or process 46 of [FIG. 10]. Apparatus 10 can optionally include a casing 11 mounted about or on an suitable belt 33 of any suitable conveyor 30. Casing 11 can optionally include two sections, for example a first section formed by an upper chamber 12 and a second section that includes a lower chamber 15.

With reference to the air cycle of the method of the invention, air chamber plenum 29 of upper chamber 12 (see FIGS. 2, 6a, 6b and 8) receives cooled and oil stripped air from the one or more ducts 14. Air chamber plenum 29 works as temporarily air tank storing a mass volume of cooled oil stripped air. Such temporarily storage can also serve as an air damping factor device that can even the air energy of the incoming cooled oil stripped air supplied by the one or more ducts 14. In a forced convection manner, the oil stripped cool air stored in the air chamber plenum 29 passes thru heater 27, where it is heated to a suitable temperature. Suitable air temperatures can optionally ranges from 25° C. up to 200° C., as a function of a variety of factors of the process. The forced convection of the air is promoted by a fan 17 driven by a motor 28. As can be seen in FIGS. 2, 6a, 6b and 8, the fan 17 can optionally be placed between the heater 27 and a nozzle 16, which gives the fan 17 the ability to suck air from the air chamber plenum 29 and blow the air through the nozzle 16. The air flow through the nozzle can be of any suitable rate, including for example at a rate ranging from 900 m3/h up to 18689 m3/h, depending on the speed of the motor 28. The air flow through nozzle can be a function of a variety of factors of the process. The combination of the fan 17 and the nozzle 16 can optionally be referred to as a blower.

Air from the nozzle showers the edible goods, items or foodstuff, for example placed on racks 36 carried by conveyor 30. As discussed above, racks 36 can optionally be referred to as shelves, platforms or support structures. The racks 36 can serve as part of the receptacles of the invention for receiving and positioning food items during the oil removal process of the invention. Nozzle 16 is optionally set over the entire width of the belt 33 of conveyor 30 and optionally set over the entire width of link racks 36 of the receptacles carried by the conveyor, providing an oil stripped hot air curtain or shower or jet along the whole width of the section of the belt 33 and link racks 36 located underneath the nozzle 16. The nozzle optionally has a width approximating the width of belt 33 of the conveyor 30. The curtain or shower of oil stripped hot air drags and acquires oil as it contacts the oil rich surfaces of the edible goods or food items carried by conveyor 30, for example on link racks 36 of belt 33, causing the food items to be oil stripped and transferring the oil to the air stream.

If the shape or geometry of the fried foodstuffs or food items allows it, for example the shape of the food items are discoidal, or thin strips or slices, the fried edible goods or food items can optionally be placed sideways or on their edge within the receptacles, for example on link racks 36, so that one or both of the longitudinal faces of the food items are parallel or approximately parallel to the air stream of the curtain or shower of oil stripped hot air mass flow expelled by the nozzle 16. Food items that are approximately parallel to the air stream can be referred to as being inclined or slightly inclined to the air stream. Examples of food items that are discoidal, or thin strips or slices, include without limitation fried tortillas, sliced mushrooms, potato chips, banana or plantain slices, or some other kind of fungi, fruit, vegetable or tubercle sliced or in thin strips. When the fried edible good or food item is placed sideways or on their edge, periphery or side periphery on the link racks 36, its longitudinal face is parallel or approximately parallel to the air stream of the curtain or shower oil stripped hot air mass flow expelled by the nozzle 16. With this arrangement, the edible goods or food items expose most of their outer surfaces without blocking the hot air mass flow, promoting contact of the oil dragging hot air mass flow with the outer surfaces and improving the oil removal from the outer surfaces. This arrangement can also improve the oil transfer to the hot air mass flow, improve the air flow, avoid undesired collision with objects that might cause an undesirable oil transfer or any combination of the foregoing.

Any food item can be aligned, for example by placement in a receptacle, parallel or approximately parallel to the air stream from nozzle 16. Food items that are aligned parallel to the sir stream from the nozzle can be referred to as being disposed at a right angle to the conveyor. Food items that are inclined relative to the air stream from the nozzle can be referred to as being inclined relative to the direction of travel of the conveyor. Food items can optionally extend or be aligned at an acute angle to the flow of air. Such angle can optionally range from zero to 60 degrees. Such angle can optionally range from zero to 45 degrees. Such angle can optionally range from zero to 30 degrees. Such angle can optionally range from zero to 15 degrees. Such angle can optionally range from zero to five degrees. When such angle is relatively small, the food items can be referred to as being aligned approximately parallel to the air stream from nozzle 16.

When the fried foodstuffs or food items have a round shape, for example like mushrooms or fried balls of any sort, for have an irregular shape like fried chicken, the fried foodstuffs or food items can optionally be placed on square or rectangular tray or basket shaped link rack 36 of a receptacle, for example by themselves. Such an arrangement can provide enough space between the fried foodstuffs or food items for the air to go around most of the outer area or skin of the food items without collapsing or hiding surface area of other stacked food items. This arrangement can expose most of the outer area surface or skin of the food items to the hot air shower so as to drag or remove most of the oil on the surfaces of the food items.

The cooked edible goods, fried foodstuff or food items set on link racks 36 of receptacles continue on the belt 33 of the conveyor 30 until their collection at the distal end of the conveyor 30.

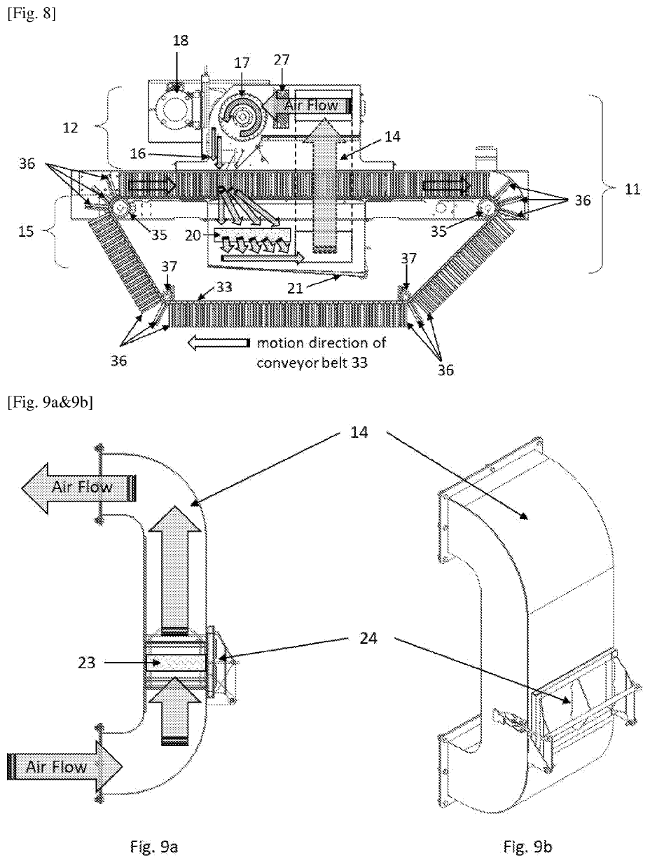

The oil saturated cool air stream which has showered the edible goods or food items carried by the conveyor 30 is optionally received by the lower chamber 15 of apparatus 10, for example an inlet duct of the lower chamber 15. Said oil rich air located below the conveyor band 33 and within the lower chamber 15 point has lost heat and gained oil, when compared to the air transported within the nozzle 16). Such oil rich cold air is optionally forced to pass or directed through a first oil removal means 20, which removes a large part of oil from the air and likely causes the air to lose more heat. A first oil stripped air stream is outputted by the first oil removal means, and has lost a good amount of heat and oil. The first oil stripped air stream is optionally suctioned by the lower part of a duct 14, where is transported to the air chamber plenum 29 of the upper chamber 12 (see FIGS. 8, 9a and 9b). A second duct 14 can optionally be provided, as is shown in FIGS. 8, 9a and 9b. for additionally directing first oil strip air to air chamber plenum 29. The at least one duct 14 can optionally be outfitted with a second oil removal means 23, which further strips oil from the cold first oil stripped air stream as it ascends through the at least one duct 14. The air stream delivered to the air chamber plenum 29 is a cold once or twice oil stripped air stream, where it is momentarily stored and later sucked by fan 17 forcing its way to the nozzle 16 once again.

Conveyor 30 can be of any suitable type, as discussed above, and optionally comprises a pair of beams 32, which can optionally have a “C” profile and be manufactured in steel or extruded aluminum. The beams 32 can optionally be supported by a plurality of feet 38, for example two feet per beam 32 in a table like manner. On the lower part of the feet, a mechanism for height adjusting 39 is optionally provided. Feet 38 are optionally manufactured in steel or extruded aluminum. Feet 38 optionally have angled profiles, for example of the “L” or “C” type. The feet 38 can be mechanically fixed to the beams 32 in any suitable manner. A roller 35 is placed on the distal end of each beam 32 and fastened to the beam by a pair of rowlocks (not shown) that are mechanically fixed to the beam 32. Similarly, lower rollers 37 can be placed on the feet 38, fastened by rowlocks (not shown) that are mechanically fixed to the corresponding feet 38.

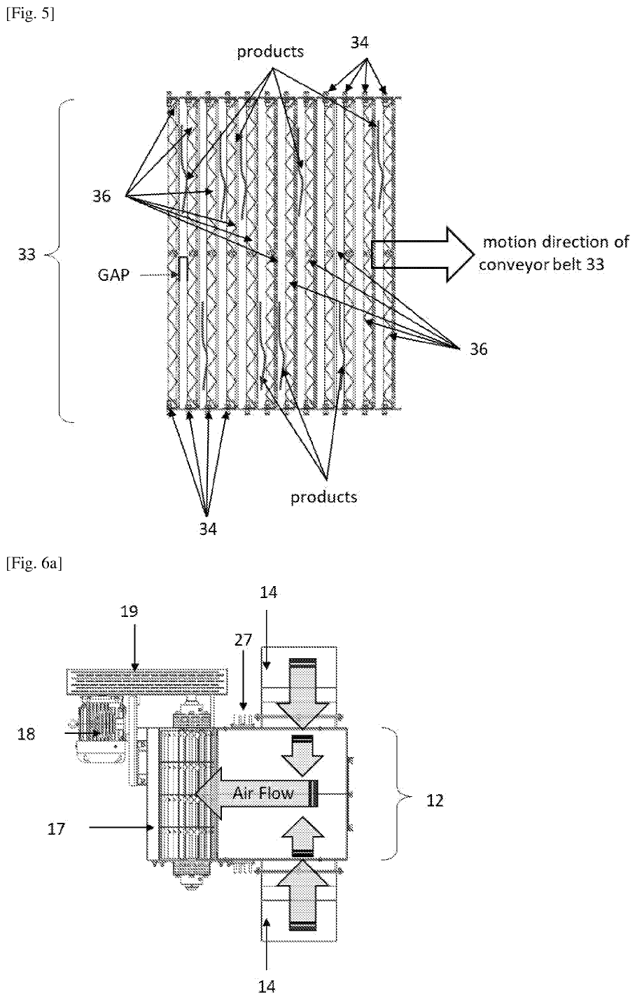

Over the pair of rollers 35 and the pair of lower rollers 37 a band 33 can be disposed. Band 33 can be constituted or formed by a plurality of links 34, joined by pins (not shown). The number of links 34 can be determined as a function of the width and length of the band 33, each of which can be of any suitable size. The width of the band 33 can optionally measure from approximately 30 centimeters (11.8 inch) to 150 centimeters (59 inch). The length of the band 33 can optionally measure from approximately 2 meters (6.5 feet) to 8 meters (26.2 feet). The width and length of band 33 can depend upon the size of the facilities and the desired production output desired (product per minute). The links 34 are optionally permeable, thus allowing the passage of an air flow through them (see [FIG. 5]). The width of each link 34 can optionally measure from approximately 5 centimeters to 20 centimeters, and the length of each link 34 can optionally measure from approximately 5 centimeters to 50 centimeters. Such width and length can depend upon the kind and size of the edible goods or food items to be transported by the conveyor. The links 34 are optionally manufactured from steel or aluminum.

Over each link 34, a link rack or rack 36 can be mechanically fixed and can optionally extend across the entire width of the band 33. The rack 36 can be of any suitable type, for example as discussed above, and can optionally be made out of steel or aluminum. Each rack can optionally have an “L” shape, as can be seen in FIGS. 2, 4 and 8, that serves to hold sliced, stripped or disk shaped cooked edible goods or food items. Such “L” shape can include a side surface or lip extending outwardly from the main support surface of the rack for supporting one or more food items on its edge or periphery. The side surface or lip can optionally extend across all or a potion of the side of the width of the rack furtherest from the nozzle. Each rack 36 can optionally have a tray or basket shape of the rectangular or square kind (not shown), for example to hold round or elliptical or non-geometrically shaped cooked edible goods or food items which can optionally be placed individually in a such a tray or basket. The racks 36 can allow the passage of air flow therethrough. The rack can optionally be manufactured out of bars folded at one end at 90°, allowing sufficient material at the protuberance, which also serves as a separator or GAP (see [FIG. 5]) between contiguous or adjacent racks 36. The GAP can serve as a space of a receptacle of the apparatus 10 for receiving one or more cooked edible goods or food items, as discussed above. The GAP can optionally be substantially less than the length and width of the space between adjacent racks 36. The bars can optionally be folded on their ends and arranged in a grill like manner, which can help to align the oil stripped hot air stream expelled from the nozzle 16 to the surface of the one or more cooked edible goods or food items placed on the rack 36. Such construction of the bars and rack can optionally serve to expose most of the outer area or skin of the one or more food items, avoid staking and promoting the oil stripped hot air stream that emanates from the nozzle 16 to air shower the one or more food items and drag most of the oil located on the surfaces of the food items, inhibiting air flow restrictions or hindering. Each rack 36 can optionally have a length and width substantially larger than its depth. The width of each rack can optionally approximate the width of the belt 33 of the conveyor. Each rack 36 can optionally have a width of approximately between 30 centimeters (11.8 inches) to 150 centimeters (59 inches), depending on the required production output, for example products processed per minute, for which the apparatus 10 has been dimensioned. The length of each rack 36 can optionally range from approximately 2.5 centimeters (approximately 1 inch) to 20 centimeters (7.8 inch), dependings on the type of edible goods or food items to be transported and its shape, geometry and physical measurements. The racks 36 can optionally receive and hold the one or more food items free of compressive forces so as to not damage the one or more food items during processing by the apparatus of the invention.

Where the foodstuffs or food items possess a discoidal, sliced or thin strip geometry. each rack 36 can carry between 5 to 300 objects each arranged vertically, for example on its edge or periphery. The optional side surface or lip of the rack can serve to support one or more food items vertically on the rack of the receptacle. Where the foodstuffs or food items have a different geometry, for example stick, round, elliptical, stripes or bars, they can optionally be laid the racks 36. Where the foodstuffs or food items have a stick, stripe or bar geometry, for example like French fries or cheese sticks, the food items can optionally be placed in a colander or wire basket (not shown) mechanically fixed to the rack 36 in any suitable manner. Where the foodstuff or food items can be placed in a vertical or inclined fashion, a plurality of 5 to 100 food items or can be placed standing in each wire basket. Each rack 36 can optionally have a rectangular or square shape, for example to hold shaped cooked edible goods or food items like fried chicken. Each rack 36 can optionally be provided with a colander or wire basket (not shown) that can be mechanically fixed to the rack, for example for holding complicated or random non geometric form cooked edible goods or food items like fried tortilla stripes, fried strips of pork skin (pork rind), flour crackling, cheese balls, or fried chicken. Each colander or wire basket can optionally be constructed or configured to hold approximately between 10 grams to 1 kilogram of food items. The number of racks 36 in conveyor can optionally be a function of the width of the conveyor or apparatus and the desired product output of the apparatus.

The belt 33 of conveyor 30 can be driven in any suitable manner, for example by a distal roller 35 mechanically coupled to a motor 31 with a gearbox (not shown). Motor 31 can be of any suitable type, for example an electric or pneumatic motor, and can be controlled by any suitable control system (not shown).

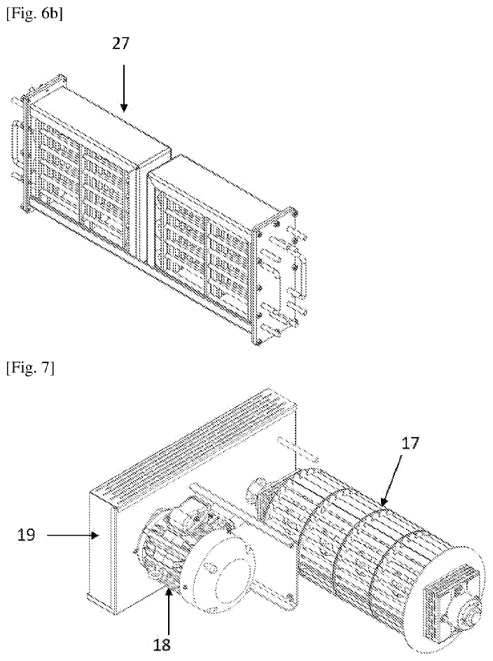

The upper cavity 12 of the casing 11, which can be seen in FIGS. 2, 6a and 6b, optionally houses the heater 27, which can optionally be an electric heater. Heater 27 can optionally be a heat exchanger, for example operated by hot fluids which exchange heat with the fan 17 sucked air from the air plenum 29. A combustible burner can optionally be used to heat the oil desiccated air from the air plenum 29. The embodiment of the heater 27 illustrated in [FIG. 6b] is has a zigzag shape. The heater 27 can optionally have a nested shape, for example a series of rectangular electrical resistances nested within each other. The heater can optionally have a series of electrical resistances with a larger perimeter. A rectangular or pyramid shape as well as thermal fins can optionally be provided the heater, among other shapes or arrangements which will allow the bars of the heater to have a longer contact time with the air.

The heater 27 can optionally be able to provide between 3 kW to 5 KW and can optionally have a heating capacity ranging from 50° C./m3 up to 150° C./m3. The hot air stream outputted from the heater may optionally reach a temperature range between approximately 25° C. to 200° C., which can depend on factors that include the heating capacity of the heater 27 and the mass flow of air which the fan 17 can deliver. The heater 27 can optionally be energized by an electric driver (not shown) of any suitable type, for example a coil relay or solid state, valve or any other type of mechanism which allows connecting to the feeding source. The driver can optionally be operated by the control system, which can optionally sends a low voltage control signal for energizing or de-energizing the heater.

The casing 11 can manufactured by any suitable means and from any suitable material, for example steel sheet, plate or laminate optionally reinforced by a structure made of an extruded steel profile for providing the casing 11 with the necessary stiffness.

The upper chamber 12 can optionally include at least one aperture located in the air chamber plenum 29. The aperture can optionally be in fluid communication with a given duct 14. The upper chamber 12 can optionally be provided with at least two apertures, where each aperture is in fluid communication with a given duct 14, for example one of a pair of ducts 14. As can be seen in FIGS. 1 and 2, the upper chamber 12 air chamber plenum 29 can optionally be provided with a window 25 with a lid mechanically fastened to the upper chamber 12, which can allow access to the heater 27 and can serve as an inspection point for the upper chamber 12 and the fan 17. The whole upper chamber 12 can optionally be thermally isolated by any suitable means. The heater 27 section of the upper chamber 12 can optionally be thermally isolated, which partial thermal isolation can be accomplished by any suitable means.

The fan 17 can optionally be of a squirrel cage type, with a capacity optionally ranging from between 529.7 CFM (900 m3/h) to 11000 CFM (18689 m3/h). As illustrated in [FIG. 7], fan 17 can optionally be coupled by means of pulleys and band (not shown) to motor 18. The band and pulleys can optionally be covered by a guard 19, which can prevent the user from coming into contact with moving parts. The motor 18 can optionally be triphasic electric, optionally ranging from between 3 hp to 5 hp, and can optionally operate at 440 Vac with an optional frequency of 45 Hz. The motor can optionally have other configurations for both voltage and frequency, for example 220 Vac to 60 Hz or can optionally be an DC electric motor. The motor 18 can optionally be of the pneumatic type, optionally ranging from 3 hp to 5 hp and optionally operating at a pressure of 6 bar. The motor 18 is optionally coupled to a driver (not shown), which can receive a low voltage control signal emanating from the control system to which it is electrically coupled to energize or de-energize the motor upon contacting with the energy source. The driver of the motor can optionally have a speed variator or a frequency variator for regulating the rotating speed of the motor 18. A pneumatic motor 18 can optionally be provided with a flow regulator valve for adjusting the air mass flow and the pressure at which said pneumatic motor 18 operates, thus permitting a user to regulate the rotational speed of the pneumatic motor 18. Manipulation of the speed of the motor 18 varies the speed of the fan 17 and thus the flow and velocity of the air outputted by nozzle 16.

The nozzle 16 can be of any suitable type. The nozzle is optionally manufactured in steel sheet, plate or laminate, its structure optionally made of extruded steel profile. As can be appreciated, nozzles can be provided to direct a fluid mass, lower a fluid velocity, increase or maintain a fluid velocity and perform other tasks. Certain zones of a nozzle can experience fluid acceleration, fluids deceleration or null acceleration, such characteristic associated with physical type and dimensions of the nozzle. Nozzles can transport and arrange the flow generated from various flow patterns, for example a curtain, cone, point or jet stream. Nozzle 16 optionally has a horizontal cross section that is similar in its longitudinal dimension to the width of the conveyor belt 33, facilitating the oil stripped hot air curtain or shower from the nozzle bathing the edible goods or food items placed on the racks 36 of the conveyor belt 33. The air speed leaving the nozzle 16 can optionally range from approximately 2 m/s to 10 m/s, depending on a number of factors that can include the cross section area available in the nozzle 16, the air mass flow provided by the fan 17 or both. The lateral cross section of the nozzle 16 can optionally be a bit wider on its end closer to the fan 17. The lateral cross section of the nozzle can optionally decrease as it approaches the conveyor belt, which can maintains or slightly accelerate the oil stripped hot air mass flow speed, which may represent a rate in the variation of the air speed through the nozzle 16 of approximately 0.00 m/s to approximately 1 m/s. The nozzle 16 may optionally be configured to give direction to the oil stripped hot air that travels within the nozzle 16. The lower part of the nozzle 16 may optionally have one or more deflectors (not shown), which can help direct the oil stripped hot air over the racks 36 of the conveyor belt 33. The deflectors can optionally be adjustable, which can permit the direction of the oil stripped hot air flow outputted from the nozzle to change, for example as a function of the type of edible goods or food items transported on the racks 36 of the conveyor belt 33.

The lower chamber 15 of the casing 11 can optionally be set below the conveyor belt 33, for example as shown in FIGS. 8, 2 and 6a. The lower chamber 15 can optionally contains the first oil removal means 20. The lower chamber can optionally connect to at least one duct 14 that can be mechanically fixed to the lower part of the side of the lower chamber 15 so as to be in fluid communication with the lower chamber 15. The lower chamber 15 can optionally connect to at least one pair of ducts 14 that are in fluid connection and mechanically fixed to the lower sides of the lower chamber 15. The oil collected by the first oil removal means 20 can tend to drip due to its temperature and fluidity by means of gravity towards the hopper 21 set on the lower part of the lower chamber 15. The oil collected by the hopper 21 can be extracted by means of a drainage pipe with a valve (not shown).

The at least one duct 14 can optionally be manufactured in steel sheet, plate or laminate. The at least on duct can optionally be reinforced by a structure made of extruded steel profile. The at least one duct 14 can connect the upper chamber 12 with the lower chamber 15, separated by the conveyor belt 33, in a fluid manner as shown in FIGS. 9a and 9b. The at least one duct 14 can optionally be outfitted with a second oil removal means 23, and optionally provided with a service port 24 with a lid mechanically fixed to the duct 14.

In some aspects of the invention, an oil stripping apparatus for edible goods or foodstuff can be provided that includes an upper chamber, a lower chamber, a fan, a heater, a conveyor belt with links, the apparatus can include a plurality of permeable link racks for supporting the edible goods or foodstuff, the permeable link racks set on links of the conveyor belt, an air chamber plenum located in the upper chamber in fluid communication with the heater, wherein the fan sucks air from the air chamber plenum and forces the air thru the heater causing the air to gain temperature and deliver heated air, a nozzle which receives the heated air and is placed on the upper chamber to direct an air shower towards the edible goods or foodstuff supported on said plurality of permeable link racks, where oil located on the foodstuffs surface is transferred to the heated air, at least one first means of oil removal that strips oil from the oil rich air and at least one duct which transports the oil stripped air from the lower chamber to the air chamber plenum.

The heater can optionally be of the electric kind. The heater can optionally include a zig zag shape or nested shape. The heater can optionally be a heat exchanger operated by fluids. The heater can optionally include a burner. The first oil removal means can optionally be located in the lower chamber under the conveyor belt. The lower chamber can optionally include a hopper that collects the dripping oil from the first oil removal means. The at least one duct can optionally be equipped with a second oil removal means. The at least one duct can optionally include a service port. The duct service port can optionally include a lid. The first oil removal means can optionally be a filter. The second oil removal means can optionally be a filter. The fan can optionally be of the squirrel cage type. The link racks wide dimension can optionally approximately the same as the longitudinal dimension of the nozzle. The edible goods can optionally be fried corn tortillas ortostadas.

In some aspects of the invention, an oil stripping method for edible goods or foodstuff can be provided that include placing the edible goods or foodstuffs in link racks, heating oil stripped air located in an air chamber plenum and delivering said oil stripped hot air to a nozzle, creating a hot air stream with said oil stripped heated air to shower the edible goods or foodstuff placed on the link racks, dragging any excess oil in the edible goods or foodstuff surface and transferring said excess oil to the air stream, stripping oil from the oil rich air and transporting the oil stripped air to the air chamber plenum.

### Example

This example involves a lot sample of fried foods such as fried corn tortillas (tostadas), a portion (a piece), which has a weight of approximately 12 g of corn mass, with a 22% weight of oil. The lot sample arrives through a conveyor which is coupled to the conveyor belt 33. The fried foods are carefully deposited sideways over its edge into the link rack 36. The tostadas are dispersed along the length of the link rack 36 in such a way that they do not end one top of one other. The conveyor 30 continuously operates at an even speed of approximately 1 m/min. The fried edible goods or foodstuffs placed in the link racks 36 travel to a location underneath the nozzle 16, which with the help of a fan 17 generates a curtain or shower of hot air at 120° C., with a mass flow of air from 6500 cfm (11043.57 m3/h) and at a velocity of 5.6 m/s. At this temperature the palmolein oil used in the tortilla frying process has a fluidity of 0.0378 kg/m*s (any other unit for fluidness or viscosity can be used), which allows the curtain or shower of oil stripped hot air to drag the oil found on the surface of the tostada thus transferring the oil to the air stream and transporting the oil rich air through the conveyor belt 33 into the lower chamber 15. The oil rich air continuing its way until it reaches the first oil removal means 20, which for this example is a filter, wherein the particles measuring 10 μm are trapped by the first oil removal means 20 (filter). The oil that drips from the first oil removal means 20 (filter) is trapped in the hopper 21 and is collected for its later use. The oil stripped cold air found in the lower chamber 15 and which has passed through the first oil removal means 20 (filter) is suctioned by the lower part of a pair of ducts 14 (that are used in the embodiment of the apparatus of the invention of this example), which transport the first oil stripped cold air towards the upper chamber 12. The ducts 14, for the purposes of this example, are each outfitted with a second oil removal means 23, which for the purposes of this example is a MistPad type filter which can trap particles measuring 10 μm. For the purposes of this example it is desirable that each duct 14 be equipped with a service port 24 set with a mechanically removable lid. The air delivered by the ducts 14 to the air chamber plenum 29 is double oil stripped cold air, the air chamber plenum 29 being in fluid connection with the upper part of the ducts 14 . . . . The double stripped cold air contained in the air chamber plenum 29 is forced through the heater 27, that in this example is an electric resistance heater with 4 lines nested in a rectangular disposition which delivers 4000 W at 220 VAC, with a heating capacity of 80° C./m3 of air. The air at 120° C. (that has been double oil stripped) is now suctioned by the fan 17, which can move 9500 CFM. The fan 17 is driven by a triphasic induction motor from 440 V to 45 Hz coupled to a transmission with pulleys and band, guarded by a guard 19. An double oil stripped air mass of 100 m3 with a velocity of 5.6 m/s enters into the nozzle 16, whereby the nozzle 16, given its shape, orders the mass air flow in such a way that at the exit of the nozzle 16 the air flow mass maintains a velocity of 5.6 m/s at a temperature of 120° C. The tostadas are subjected to the heated oil stripped air curtain or shower, dragging approximately 0.02 to 0.05 grams of oil per tostada, thereby decreasing the amount of oil contained on the tostada by 1% to 4%.

Having described instant invention with sufficient detail, through which its industrial application is accredited, it is found to have a good novelty grade, as well as a good inventive level grade, so that the following claims are made given the description.

1. An apparatus for removing excess oil from a plurality of food items each having a side periphery and a face extending between the side periphery, comprising:
a plurality of sequential air permeable receptacles of a conveyor for respectively receiving the plurality of food items,
the conveyor being advanceable in a direction of travel; and
a blower having a nozzle for providing a stream of air;
characterized in that each of the plurality of receptacles has a side surface for supporting the respective food item resting on its side periphery when the respective food item has been received by the respective receptacle;
the nozzle being positioned above the conveyor for directing the stream of air downwardly towards the side periphery and across the face of the plurality of food items traveling under the nozzle to remove excess oil from the plurality of food items.

2. The apparatus of claim 1, wherein each of the plurality of receptacles has a side surface for supporting the respective food item so that the periphery of the food item is inclined at a right angle relative to the direction of travel.

3. The apparatus of claim 1, wherein each of the plurality of food items is discoidal in shape.

4. The apparatus of claim 1, wherein each of the plurality of receptacles is inclined at an angle relative to the direction of travel.

5. The apparatus of claim 4, wherein each of the plurality of receptacles is inclined at a right angle relative to the direction of travel.

6. The apparatus of claim 1, further comprising an inlet duct disposed below the conveyor for receiving oil rich air from the plurality of food items and an oil removal means in communication with the inlet duct for removing oil from the oil rich air and providing cleaned air.

7. The apparatus of claim 6, further comprising a transfer duct for transporting the cleaned air to the blower for reuse.

8. The apparatus of claim 1, wherein the conveyor has a width and the nozzle has a width approximating the width of the conveyor.

9. The apparatus of claim 1, wherein each of the plurality of receptacles has a depth and the nozzle has a depth at least approximating the depth of each of the plurality of receptacles.

10. The apparatus of claim 1, wherein each of the plurality of receptacles is configured to respectively receive the plurality of food items free of compressive forces that would damage the plurality of food items.

11. The apparatus of claim 1, wherein each of the plurality of receptacles has a space for receiving a food item, the space having a width, length and depth, the width and length of the space each being larger than the depth of the space for receiving the food item.

12. A method for removing excess oil from a plurality of food items each having a side periphery and a face extending between the side periphery, comprising:
placing the plurality of food items in a sequential manner on a conveyor advanceable in a direction of travel;
characterized in that each of the plurality of food items is inclined at an angle relative to the direction of travel of the conveyor; and
blowing a stream of air downwardly towards the side periphery and across the face of the plurality of food items to remove excess oil from the plurality of food items.

13. The method of claim 12, wherein each of the plurality of food items is inclined at a right angle relative to the direction of travel of the conveyor.

14. The method of claim 12, further comprising receiving oil rich air from below the conveyor and removing oil from the oil rich air to provide cleaned air.

15. The method of claim 12, further comprising receiving used air from below the conveyor and recirculating and reheating the used air for reuse.

16. The method of claim 12, wherein each of the plurality of food items is discoidal in shape, the blowing step including blowing a stream of air across the face of each of the plurality of food items to remove excess oil from the plurality of food items.

17. The method of claim 12, wherein the side periphery of each of the plurality of food items extends approximately parallel to the stream of air.
